(19) United States
(12) Patent Application Publication
(10) Pub. No.: US 2025/0101711 A1
(43) Pub. Date: Mar. 27, 2025

(54) ELECTRIC BREAKER ATTACHMENT

(71) Applicant: Doosan Bobcat North America Inc., West Fargo, ND (US)

(72) Inventors: Matthew Walter Keller, Bismarck, ND (US); Brian Paul Dehnert, Mandan, ND (US); David Glasser, Bismarck, ND (US)

(21) Appl. No.: 18/898,554

(22) Filed: Sep. 26, 2024

Related U.S. Application Data
(60) Provisional application No. 63/540,522, filed on Sep. 26, 2023.

(51) Int. Cl. E02F 3/96

(52) U.S. Cl. CPC E02F 3/966

(57) ABSTRACT

An attachment on a power machine includes an elongated hammer, an elongated tool and at least one electromagnetic coil. The hammer includes an upper end in sealed communication with a gas accumulator and an opposing lower end. The tool includes an upper end having an impact surface and an opposing lower end having a work surface. The tool is configured to be actuated when the lower end of the hammer collides with the impact surface of the tool. The coil surrounds a portion of the hammer and is configured to actuate the hammer into a compression stroke that moves the hammer in a first direction and a firing stroke that is further aided by compressed gas in the gas accumulator to move the hammer in a second opposing direction and cause the hammer to collide with the impact surface of the tool to actuate the tool.

### CROSS-REFERENCE TO RELATED APPLICATION(S)

This application claims the benefit of U.S. Provisional Application No. 63/540,522,filed Sep. 26, 2023, the content of which is hereby incorporated by reference in its entirety.

### BACKGROUND

The present disclosure is directed toward power machines that have attachments. More particularly, the present disclosure is related to power machines with breaker attachments.

Power machines, for the purposes of this disclosure, include any type of machine that generates power for the purpose of accomplishing a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders, excavators, utility vehicles, tractors, and trenchers, to name a few examples.

A work device on a power machine may be equipped with an attachment or implement for performing various work functions. One exemplary attachment or implement is a breaker attachment, which is a demolition machine that breaks through concrete, rock and asphalt.

The discussion above is merely provided for general background information and is not intended to be used as an aid in determining the scope of the claimed subject matter.

### SUMMARY

An attachment on a power machine includes an elongated hammer, an elongated tool and at least one electromagnetic coil. The hammer has an upper end in sealed communication with a gas accumulator and an opposing lower end. The tool includes an upper end having an impact surface and an opposing lower end having a work surface. The tool is configured to be actuated when the lower end of the hammer collides with the impact surface of the tool. The at least one electromagnetic coil surrounds a portion of the hammer and is configured to actuate the hammer into a compression stroke that moves the hammer in a first direction and a firing stroke that is further aided by compressed gas in the gas accumulator to move the hammer in a second opposing direction and cause the lower end of the hammer to collide with the impact surface of the tool to actuate the tool.

An attachment on a power machine includes an elongated hammer, an elongated tool, a hammer position sensor and a controller. The hammer has an upper end in sealed communication with a gas accumulator and an opposing lower end. The tool includes an upper end having an impact surface and an opposing lower end having a work surface. The tool is configured to be actuated when the lower end of the hammer collides with the impact surface of the tool. The hammer position sensor is spaced apart from and located above the upper end of the hammer and is configured to measure a location of the upper end of the hammer relative to the hammer position sensor. The hammer position sensor is located through a wall in the gas accumulator. The controller is configured to electrically activate the hammer into a compression stroke and a firing stroke based on measurements gathered from the hammer position sensor.

An attachment on a power machine includes an elongated hammer, an elongated tool, at least one electromagnetic coil and a controller. The hammer has an upper end in sealed communication with a gas accumulator and an opposing lower end. The tool includes an upper end having an impact surface and an opposing lower end having a work surface. The tool is configured to be actuated when the lower end of the hammer collides with the impact surface of the tool. The at least one electromagnetic coil surrounds a portion of the elongated hammer. The controller is configured to electrically activate the at least one electromagnetic coil to actuate the elongated hammer into a compression stroke that moves the hammer in a first direction and a firing stroke that is further aided by compressed gas in the gas accumulator to move the hammer in a second opposing direction and cause the lower end of the hammer to collide with the impact surface of the tool to actuate the tool.

This summary and the abstract are provided to introduce a selection of concepts in a simplified form that are further described below in the Detailed Description. The summary and the abstract are not intended to identify key features or essential features of the claimed subject matter, nor are they intended to be used as an aid in determining the scope of the claimed subject matter.

### BRIEF DESCRIPTION OF THE DRAWINGS

FIG. 1 is a block diagram illustrating the basic systems of a power machine upon which disclosed embodiments may be incorporated.

FIG. 2 is a block diagram illustrating basic systems of the power machine of FIG. 1 as are relevant to interact with an attachment upon which disclosed embodiments may be incorporated.

FIG. 3 is a perspective view of an attachment according to an embodiment.

FIG. 4 is a schematic diagram of the internal components of the attachment of FIG. 3 under one embodiment.

FIG. 5 is a schematic diagram of the attachment of FIGS. 3 and 4 illustrating a movement sequence of the hammer resulting in impact of the tool.

FIG. 6 is a schematic diagram of an attachment according to another embodiment.

FIG. 7 is a schematic diagram of the attachment of FIG. 6 illustrating a movement sequence of the hammer resulting in impact of the tool.

FIG. 8 illustrates a block diagram of the attachment illustrated in FIGS. 2-5 according to an embodiment.

FIG. 9 illustrates a block diagram of the attachment illustrated in FIGS. 6-7 according to an embodiment.

FIG. 10 is a schematic diagram of the attachment of FIGS. 3-5 in a first “dead blow” position.

FIG. 11 is a schematic diagram of the attachment of FIGS. 3-5 in a second “dead blow”

position.

FIG. 12 is a schematic diagram of the attachment of FIGS. 6-7 in a first “dead blow” position.

FIG. 13 is a schematic diagram of the attachment of FIGS. 6-7 in a second “dead blow” position.

### DETAILED DESCRIPTION OF ILLUSTRATIVE EMBODIMENTS

The concepts disclosed in this discussion are described and illustrated with reference to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Typically, existing breaker attachment technology utilizes hydraulic circuitry to provide power to a mechanism to break concrete and various other materials. Hydraulic breakers use a valve circuit to provide positive or negative vector force on a hammer via fluid pressure, resulting in a reciprocating motion of the hammer with a housing of the hydraulic breaker. The reciprocating stroke of the hammer is tuned to allow for impact with the tool when it is positioned at its highest point within a lower housing. The impact of the hammer and tool allows for the energy transfer between the two moveable parts. The energy then transfers from the tool to the target medium resulting in a breaking force. Hydraulic breakers may also use a compressed nitrogen accumulator to assist in power delivery and dampening of the hammer.

With the development of electrically powered construction equipment, some power machines have been designed to remove hydraulic circuitry entirely in favor of an electric power take-off (PTO). One challenge in creating power machines that run on electricity or battery power and are limited to an electric PTO is electrifying attachments for the power machine. For example, electrifying a breaker attachment is difficult because the hydraulic mechanism that the breaker typically works on is not easily adaptable to an electric motor. Not only does the mechanism require complying with electric power to the breaker attachment but also electrifying the dynamics in the mechanism of the breaker. Such dynamics include sliding a hammer up and down and to impact a tool that interfaces with a structure that is being demolished.

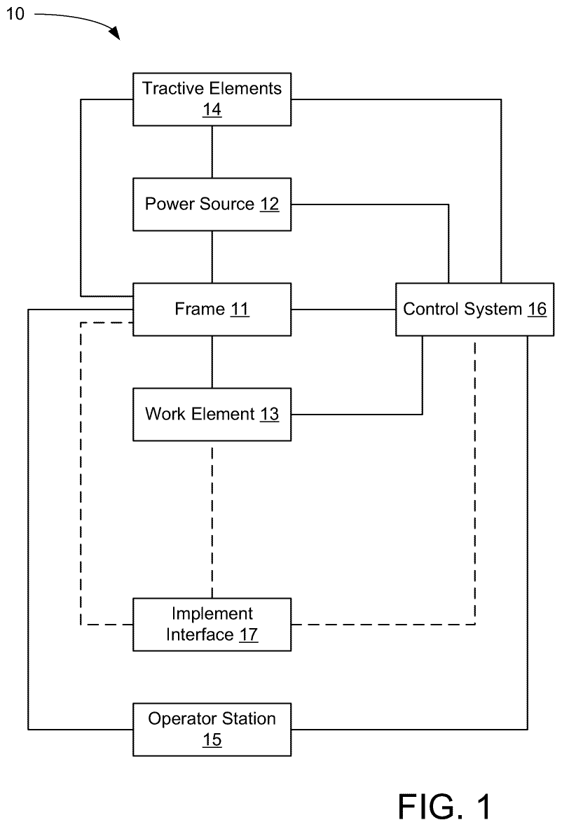

The disclosed concepts can be practiced on various types of electric power machines, as will be described below. A representative power machine on which the embodiments can be practiced is illustrated in diagram form in FIG. 1 and described below before any embodiments are disclosed. Power machines, for the purposes of this discussion, include a frame, at least one work element, and a power source that is capable of providing power to the work element to accomplish a work task. One type of power machine is a self-propelled work vehicle. Self-propelled work vehicles are a class of power machines that include a frame, work element, and a power source that is capable of providing power to the work element. At least one of the work elements is a motive system for moving the power machine under power.

FIG. 1 is a block diagram illustrating the basic systems of a power machine 10 upon which the embodiments discussed below can be advantageously incorporated and can be any of a number of different types of power machines. The block diagram of FIG. 1 identifies various systems on power machine 10 and the relationship between various components and systems. As mentioned above, at the most basic level, power machines for the purposes of this discussion include a frame, a power source, and a work element. The power machine 10 has a frame 11, a power source 12, and a work element 13. Because power machine 10 shown in FIG. 1 is a self-propelled work vehicle, it also has tractive elements 14, which are themselves work elements provided to move the power machine over a support surface and an operator station 15 that provides an operating position for controlling the work elements of the power machine. A control system 16 is provided to interact with the other systems to perform various work tasks at least in part in response to control signals provided by an operator.

Certain work vehicles have work elements that are capable of performing a dedicated task. For example, some work vehicles have a lift arm to which an implement such as a bucket is attached such as by a pinning arrangement. The work element, i.e., the lift arm can be manipulated to position the implement for the purpose of performing the task. The implement, in some instances can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 17 shown in FIG. 1. At its most basic, implement interface 17 is a connection mechanism between the frame 11 or a work element 13 and an implement, which can be as simple as a connection point for attaching an implement directly to the frame 11 or a work element 13 or be more complex, as discussed below.

On some power machines, implement interface 17 can include an implement carrier, which is a physical structure movably attached to a work element. The implement carrier has engagement features and locking features to accept and secure any of a number of implements to the work element. One characteristic of such an implement carrier is that once an implement is attached to it, it is fixed to the implement (i.e., not movable with respect to the implement) and when the implement carrier is moved with respect to the work element, the implement moves with the implement carrier. The term implement carrier as used herein is not merely a pivotal connection point, but rather a dedicated device specifically intended to accept and be secured to various different implements. The implement carrier itself is mountable to a work element 13 such as a lift arm or the frame 11. Implement interface 17 can also include one or more power sources for providing power to one or more work elements on an implement. Some power machines can have a plurality of work elements with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 11 includes a physical structure that can support various other components that are attached thereto or positioned thereon. The frame 11 can include any number of individual components. Some power machines have frames that are rigid. That is, no part of the frame is movable with respect to another part of the frame. Other power machines have at least one portion that is capable of moving with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 11 supports the power source 12, which is capable of providing power to one or more work elements 13 including the one or more tractive elements 14, as well as, in some instances, providing power for use by an attached implement via implement interface 17. Power from the power source 12 can be provided directly to any of the work elements 13, tractive elements 14, and implement interfaces 17. Alternatively, power from the power source 12 can be provided to a control system 16, which in turn selectively provides power to the elements that are capable of using it to perform a work function. In this disclosure, power sources for power machines include electrical sources such as electrical motors or a combination of power sources, known generally as hybrid power sources. For example, power machines can include electrical motors energized by electrical batteries and an engine, such as an internal combustion engine, with a power conversion system such as a mechanical transmission or a hydraulic system that is capable of converting the output from an engine into an electrical power that is usable by a work element.

FIG. 1 shows a single work element designated as work element 13, but various power machines can have any number of work elements. Work elements are typically attached to the frame of the power machine and movable with respect to the frame when performing a work task. In addition, tractive elements 14 are a special case of work element in that their work function is generally to move the power machine 10 over a support surface. Tractive elements 140 are shown separate from the work element 13 because many power machines have additional work elements besides tractive elements, although that is not always the case. Power machines can have any number of tractive elements, some or all of which can receive power from the power source 12 to propel the power machine 10. Tractive elements can be, for example, track assemblies, wheels attached to an axle, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Power machine 10 includes an operator station 15 that includes an operating position from which an operator can control operation of the power machine. In some power machines, the operator station 15 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 10 and others, whether or not they have operator compartments or operator positions, may be capable of being operated remotely (i.e., from a remotely located operator station) instead of or in addition to an operator station adjacent or on the power machine. This can include applications where at least some of the operator controlled functions of the power machine can be operated from an operating position associated with an implement that is coupled to the power machine. Alternatively, with some power machines, a remote control device can be provided (i.e., remote from both of the power machine and any implement to which is it coupled) that is capable of controlling at least some of the operator controlled functions on the power machine.

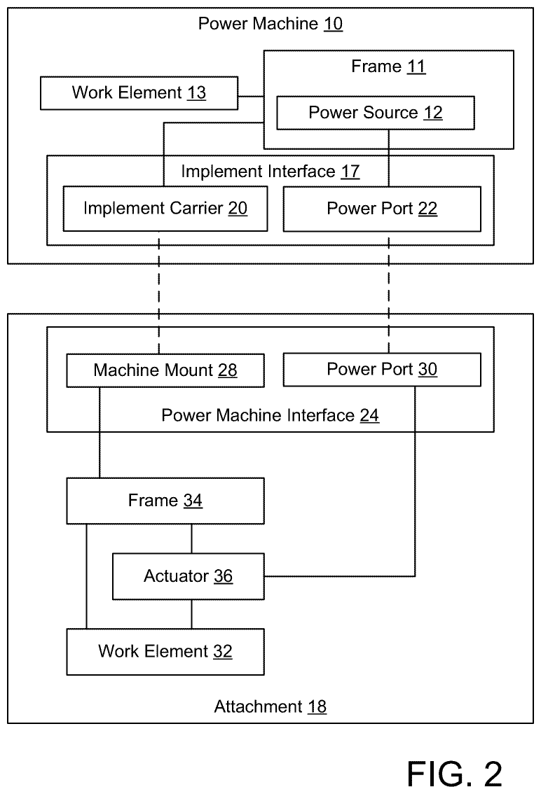

Disclosed embodiments can be practiced on various implements and various power machines. Representative attachment 18, of which the embodiments may be practiced and representative power machine 10 to which the representative attachment may be operably coupled are illustrated in diagram form in FIG. 2. For the sake of brevity, only one attachment and power machine combination is discussed in detail. However, as mentioned above, the embodiments below may be practiced on any of a number of attachments and these various attachments or implements can be operably coupled to a variety of different power machines.

FIG. 2 is a block diagram illustrating basic systems of power machine 10 as are relevant to interact with attachment 18 as well as basic features of attachment 18, which represents an attachment upon which the embodiments discussed below may be advantageously incorporated. At their most basic level, power machines for the purposes of this discussion include frame 11, power source 12, work element 13, and implement interface 17. On power machines such as loaders and excavators and other similar work vehicles, implement interface 17 includes an implement carrier 20 and a power port 22. The implement carrier 20 may be rotatably attached to a lift arm or another work element and is capable of being secured to the implement. The power port 22 provides a connection for the attachment 18 to provide power from the power source to the implement. Power source 12 represents one or more sources of power that are generated on power machine 10. This can include either or both of pressurized fluid and electrical power.

The attachment 18, which is sometimes known as an implement or an attachable implement, has a power machine interface 24 and a tool 26, which is coupled to the power machine interface 24. The power machine interface 24 illustratively includes a machine mount 28 and a power port 30 for coupling with power machine 10. Machine mount 28 can be any structure capable of being coupled to the implement interface 17 of power machine 10. Power port 30, in some embodiments, includes electrical couplers. Power port 30 can also include a wireless electrical connection, as may be applicable on a given attachment. While both machine mount 28 and power port 30 are shown, some attachments may have only one or the other as part of their power machine interface 24.

In FIG. 2, attachment 18 includes a work element 32, a frame 34 and an actuator 36. Frame 34 is coupled with or integral to the machine mount 28. Work element 32 is coupled to frame 34 and is moveable in some way with respect to the frame. Actuator 36 is mounted to frame 34 and to work element 32 and is actuable under power to move the work element with respect to the frame. Power may be provided to the actuator 36 via an electrical power take off (PTO) of the power machine, and is selectively provided in the form of electricity directly from the power machine 10 to actuator 36 via power ports 22 and 30.

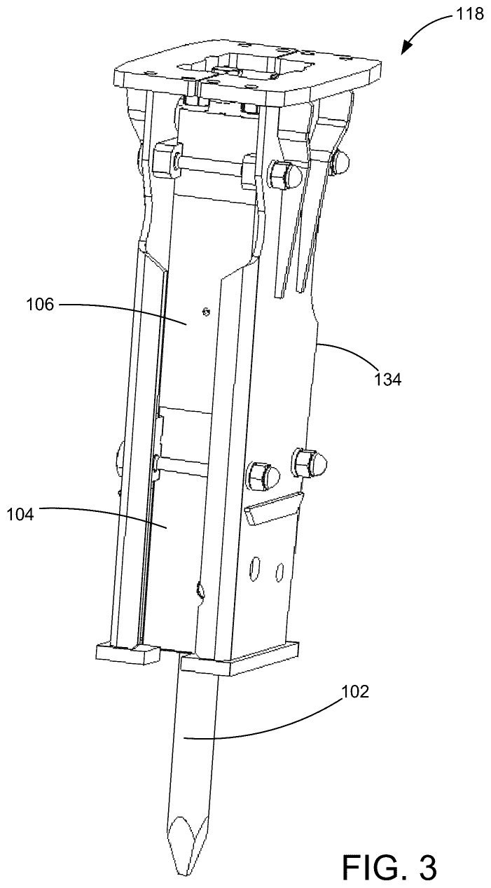

FIG. 3 is a perspective view of an exemplary electric breaker attachment 118 according to an embodiment. Breaker attachment 118 has a work element that includes a tool 102 having features and operating mechanisms for breaking through concrete, rock, asphalt or other structures. Breaker attachment 118 includes a frame 134 that supports a lower body housing 104, an upper body housing 106, tool 102 and the hammer (not shown in FIG. 3). Breaker attachment 118 utilizes the electric PTO of the power machine, such as power machine 10, to create a reciprocating motion in the hammer to produce an impacting or breaking force on tool 102, where tool 102 interfaces with a structure that is being demolished. This is accomplished by using one or more electromagnetic coils (not shown in FIG. 3) that induce a magnetic force in the hammer.

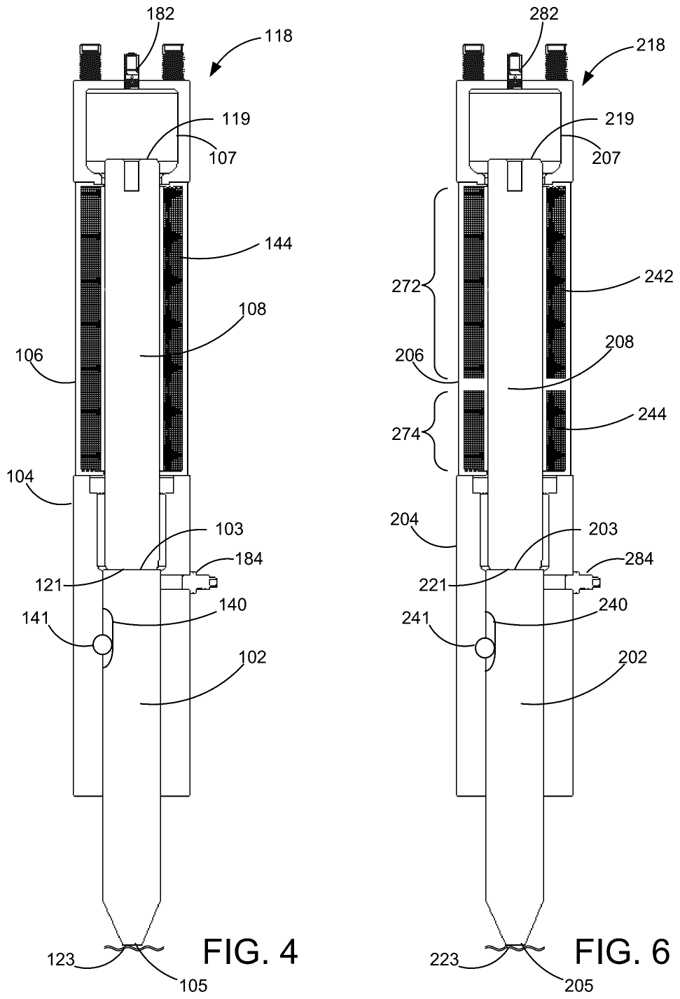

FIG. 4 is a schematic diagram of internal components of electric breaker attachment 118 under one embodiment. As previously discussed, electric breaker attachment 118 includes lower body housing 104, upper body housing 106 coupled to or fastened to lower body housing 104, elongated tool 102 and elongated hammer 108. Elongated tool 102 includes an upper end having an impact surface 103 and an opposing lower end having a work surface 105 for interfacing with a structure 123 that is being demolished. Elongated hammer 108 is contained within upper body housing 106 and includes an upper end 119 that is in sealed communication with a gas accumulator 107 and an opposing lower end 121. Tool 102 is configured to be actuated when lower end 121 of hammer 108 collides with impact surface 103. A tool slot 140 is captured and contained by a pin 141 within lower body housing 104. Tool slot 140 allows for a fixed amount of tool movement.

The electric breaker attachments described herein are powered by an electric PTO from a power machine. The electric breaker attachments include at least one electromagnetic coil that surrounds a portion of the hammer and includes a switched magnetic field that is pulsed on and off to provide the hammer of each electric breaker attachment with a reciprocating motion. The at least one electromagnetic coil is configured to actuate the hammer into a compression stroke that moves the hammer in a first direction and configured to actuate the hammer into a firing stroke to move the hammer in a second opposing direction and thereby cause the hammer to collide with the tool and actuate the tool.

In FIG. 4, a single electromagnetic coil 144 surrounds a portion of elongated hammer 108 and is fixed within upper body housing 106. As described and under one embodiment, single electromagnetic coil 144 is powered from an electric PTO from the power machine and includes a switched magnetic field that is pulsed on and off to provide hammer 108 with a reciprocating motion. Under one embodiment, single electromagnetic coil 144 may be an induction solenoid. An induction solenoid induces a magnetic field into an armature, or in this case hammer 108. Therefore, when the magnetic field is switched on, a center of hammer 108 will be induced to align with a center of the magnetic field or a center of single electromagnetic coil 144.

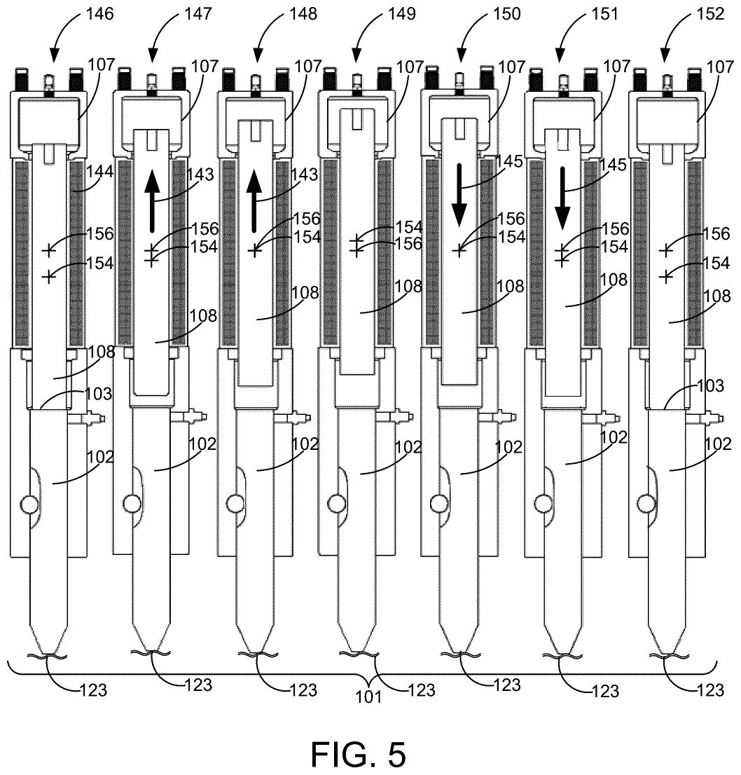

FIG. 5 is a schematic diagram of electric breaker attachment 118 in different positions to illustrate a movement sequence 101 of elongated hammer 108 throughout operation of the compression stroke and the firing stroke resulting in impact of elongated tool 102. At its initial position 146, a center 154 of hammer 108 is below a center 156 of single electromagnetic coil 144 and hammer 108 is static against an impact surface 103 of tool 102. When single electromagnetic coil 144 is provided with a first pulse of electrical current or is turned on and a first temporary magnetic field is created, hammer 108 is forced upwards, in a first direction 143, as illustrated by position 147, due to the induced magnetic field, and induces a center 154 of hammer 108 to align with a center 156 of coil 144. This linear movement of elongated hammer 108 up and away from elongated tool 102 and into a gas accumulator or chamber 107 is referred to as the compression stroke. For example, the gas may be nitrogen and the accumulator or chamber 107 may be a nitrogen accumulator or chamber. Accumulator or chamber 107 is sealed around a distal end of hammer 108 that includes upper end 119 and accumulator 207 includes charge ports for pressurizing the gas in the cavity of accumulator 107. During the compression stroke and before center 154 of hammer 108 and center 156 of magnetic coil 144 converge as illustrated by position 148, current to magnetic coil 144 is removed or shut off and the magnetic force dissipates. As illustrated by position 149, linear movement of elongated hammer 108 will continue away from tool 102 due to inertia. The inertia energy decays as it is transferred into compressing gas in accumulator or chamber 107. The transfer of energy will continue until the motion of elongated hammer 108 is stopped entirely.

Once hammer 108 is momentarily stopped at the top of the compression stroke, single electromagnetic coil 144 will then be powered again with a second pulse of electrical current. This will result creating a new, second temporary magnetic field that will induce center 154 of hammer 108 to move in a second opposing direction 145 back down toward tool 102 to align with center 156 of single electromagnetic coil 144. This downward linear movement of hammer 108 towards tool 102 as illustrated by positions 150, 151 and 152 is the fire stroke. The motion induced by the second magnetic field will be aided by the compressed gas in accumulator or chamber 107 pushing hammer 108 downward, resulting in a net high force and acceleration of the hammer back down into tool 102 at impact interface 103 as shown in position 152. In position 152, the kinetic energy from moving hammer 108 is transferred into tool 102 upon impact, providing a targeted amount of kinetic energy into tool 102. In position 152, tool 102 is in contact with a target medium or structure 123. The effect is that the energy in tool 102 is directed into the target medium or structure, such as concrete.

FIG. 6 is a schematic diagram of internal components of an electric breaker attachment 218 under another embodiment. Electric breaker attachment 300 includes lower body housing 204, upper body housing 206 coupled to or fastened to lower body housing 204, an elongated tool 202 and an elongated hammer 208. Elongated tool 202 includes an upper end having an impact surface 203 and an opposing lower end having a work surface 205 that interfaces with a structure 223 that is being demolished. Elongated hammer 208 is contained within upper body housing 206 and includes an upper end 219 that is in sealed communication with a gas accumulator 207 and an opposing lower end 221. Tool 202 is configured to be actuated when lower end 221 of hammer 208 collides with impact surface 203. A tool slot 240 is captured and contained by a pin 241 within lower body housing 204. Tool slot 240 allows for a fixed amount of tool movement.

In FIG. 6, breaker attachment 218 includes two electromagnetic coils 242 and 244 that surround hammer 208 and induce a magnetic force. Under one embodiment, first and second electromagnetic coils 242 and 244 are fixed within upper body housing 206, powered from an electric PTO from the power machine and are each separably switched on and off to provide hammer 208 with a reciprocating motion. First electromagnetic coil 242 is located above and spaced apart from second electromagnetic coil 244. In particular and as illustrated, first electromagnetic coil 242 surrounds a first portion of hammer 208 and spans a height 272 within upper body housing 206 that is greater than a height 274 of second electromagnetic coil 244. Second electromagnetic coil 244 surrounds a second portion of hammer 208 and spans a height 274 that is less than height 272 of first electromagnetic coil 242.

Under one embodiment, first and second electromagnetic coils 242 and 244 may be induction solenoids. An induction solenoid induces a magnetic field into an armature, or in this case hammer 208. Therefore, when the magnetic field is switched on in either coil 242 or 244, a center of hammer 208 will be induced to align with a center of the magnetic field or a center of corresponding electromagnetic coil 242 or 244.

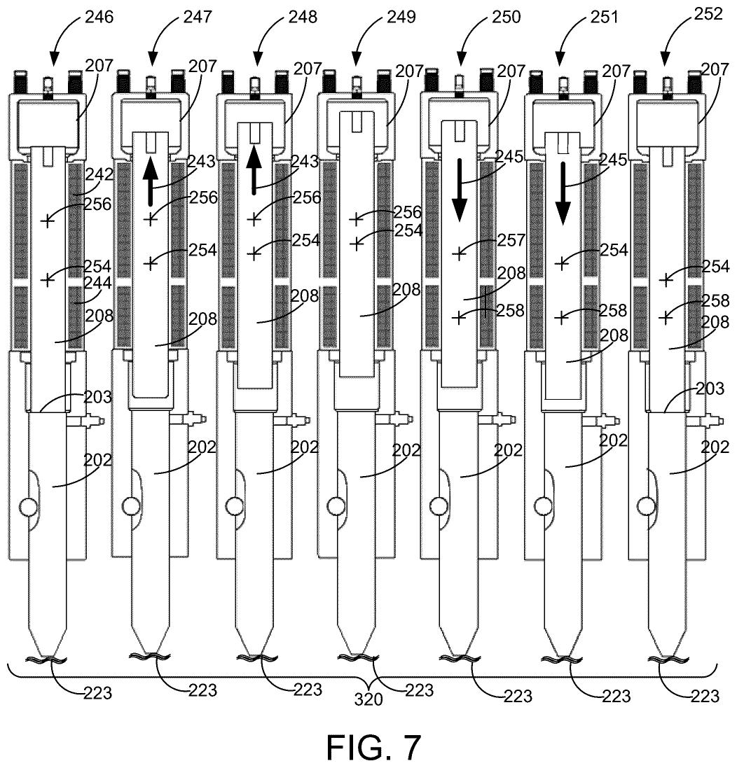

FIG. 7 is a schematic diagram of electric breaker attachment 218 illustrating a movement sequence 201 of elongated hammer 208 throughout operation of the compression stroke and the firing stroke resulting in impact of tool 202. At its initial position 246, a center 254 of hammer 208 is below a center 256 of first electromagnetic coil 242 and hammer 208 is static against an impact surface 203 of tool 202. When first electromagnetic coil 242 is provided with a first pulse of electrical current or is turned on and a first temporary magnetic field is created, hammer 208 is forced upwards, in a first direction 243, as illustrated by position 247, due to the induced magnetic field, and induces center 254 of hammer 208 to align with center 256 of first electromagnetic coil 242. This linear movement of elongated hammer 208 up and away from elongated tool 202 and into a gas accumulator or chamber 207 is referred to as the compression stroke. For example, the gas may be nitrogen and the accumulator or chamber 207 may be a nitrogen accumulator or chamber. Accumulator or chamber 207 is sealed around a distal end of hammer 208 that includes upper end 219 and accumulator 207 includes charge ports for pressurizing gas into its cavity. During the compression stroke and before center 254 of hammer 208 and center 256 of first magnetic coil 242 converge as illustrated by position 248, current to first magnetic coil 242 is removed or shut off and the magnetic force dissipates. As illustrated by position 249, linear movement of hammer 208 will continue away from tool 202 due to inertia. The inertia energy decays as it is transferred into compressing gas in accumulator or chamber 207. The transfer of energy will continue until the motion of the hammer is stopped entirely.

Once hammer 208 is momentarily stopped at the top of the compression stroke, second electromagnetic coil 244 is provided with a second pulse of electrical current or is turned on, and a second temporary magnetic field is created that will induce center 254 of hammer 208 to move in a second opposing direction 245 back down toward tool 102 to align with a center 258 of second electromagnetic coil 244. This downward linear movement of hammer 208 towards tool 202 as illustrated by positions 250, 251 and 252 is referred to as the fire stroke. The motion induced by the second magnetic field in second coil 244 will be aided by the compressed gas in accumulator or chamber 207 pushing hammer 208 downward. Therefore, second coil 244 need not be as large as first coil 242. In position 252, the kinetic energy from moving hammer 208 is transferred into tool 202 upon impact, providing a targeted amount of kinetic energy into tool 202. In position 252, tool 202 is in contact with a target medium or structure 223. The effect is that the energy in tool 202 is directed into the target medium or structure, such as concrete.

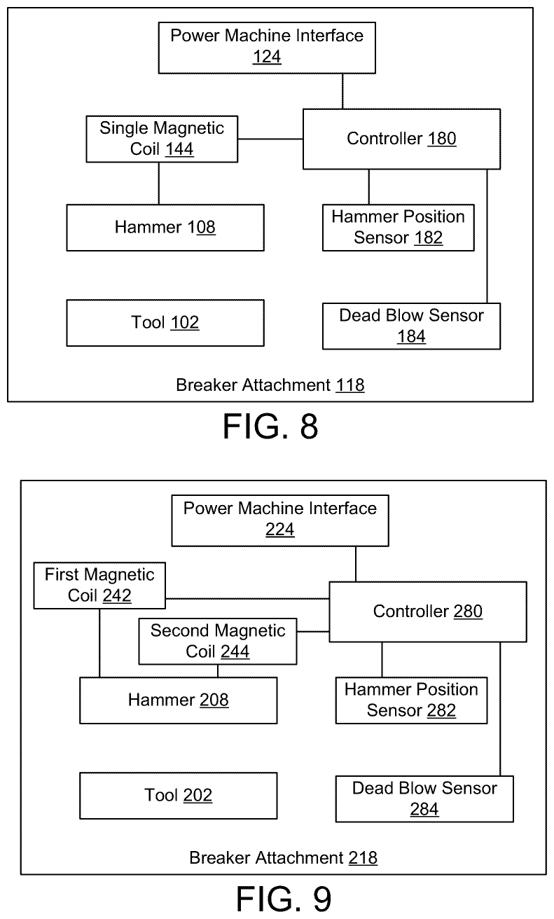

In each of electrical breaker attachments 118 and 218, the compression and fire strokes will occur several times per second. This performance parameter requires high precision monitoring and control of the hammer movement. Under one embodiment, FIG. 8 illustrates a block diagram of electrical breaker attachment 118 illustrating the control of hammer movement in a closed loop sensor system that communicates with a controller 180 supplying current to single magnetic coil 144. The closed loop sensor system includes two sensors. A first sensor is a hammer position sensor 182 that is located axially in-line with hammer 108 and interfaces with accumulator or chamber 107 through a threaded hole and seals with accumulator or chamber 107 with a plurality O-rings as illustrated in FIG. 4. A second sensor is one or a series of more than one dead blow sensors 184 placed along a length of tool 102 as illustrated in FIG. 4. In one embodiment, each of first and second sensors 182 and 184 are light-based sensors, such as laser-optical sensors. However, other sensors are possible including Hall Effect sensors, pressure sensors, ultrasonic sensors and the like. Regardless, first and second sensors 182 and 184 include pressure and vibration ratings that can withstand expected operation pressures and vibrations.

First sensor or hammer position sensor 182, when light-based sensor, uses reflected laser light to accurately measure the linear position or location of hammer 108 and optimize the timing of providing current to coil 144 for activating the compression stroke and the firing stroke. As illustrated in FIG. 4 and under one embodiment, the signal from hammer position sensor 182 is provided to controller 180 and in turn controller 180 electrically activates or provides electrical current to coil 144 from the power machine via a power machine interface 124 based on the signal of hammer position sensor 182 to activate the compression stroke or the firing stroke. Second sensor or dead blow sensor 184, when light-based, operates via line-of-sight to ensure presence of hammer 108 and or tool 102 at the location of dead blow sensor 184 to initiate hammer movement. Dead blow sensor 184 provides a signal if a laser light is blocked by either hammer 108 or tool 102.

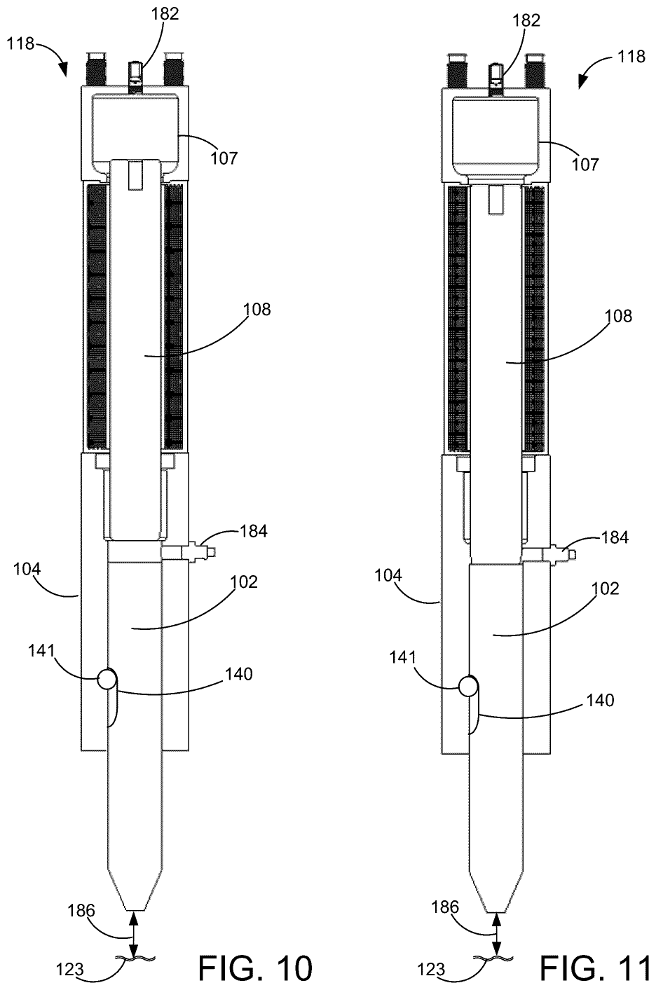

Under one embodiment, controller 180 is configured receive signals from hammer position sensor 182 and dead blow sensor 184 to ensure both hammer 108 and tool 102 are in the correct positions to operate. If hammer 108 or tool 102 is not in the path of dead blow sensor 184, and/or the position of hammer 108 is measured outside of a predetermined operation range, controller 180 determines that breaker 118 cannot be operated. This prevents firing of hammer 108 into empty space, otherwise known as a “dead-blow,” which is an unhealthy condition for breaker 118. Two such “dead-blow” positions are shown in FIGS. 10 and 11 and caused by the operator not having tool 102 loaded up against structure 123 that the operator is trying to break. If firing of hammer 108 is not prevented in a “dead-blow” position, damage to internal components in breaker 118 may occur because all of the energy of the firing stroke is acted against the breaker itself instead on structure 123.

In first exemplary “dead-blow” position in FIG. 10, there is a gap 186 between tool 102 and structure 123. Gravity causes tool 102 to slide in lower body housing 104 to its lowest position as allowed by pin 141. As illustrated in FIG. 10, dead blow sensor 184 would sense the absence of tool 102 and therefore tool 102 being in the incorrect position. This signal is fed to controller 180 and controller 180 prevents the breaker from operating. In second exemplary “dead-blow” position in FIG. 11, there is also gap 186 between tool 102 and structure 123 and gravity has caused tool 102 to slide in lower body housing 104 to its lowest position as allowed by pin 141. However, as illustrated in FIG. 11, dead blow sensor 184 would sense the presence of hammer 108, which is jammed up or stuck in the cavity and therefore mistakenly inform controller 180 that tool 102 is in the correct position. In this situation, hammer position sensor 182 would sense that hammer 108 is out of position and controller 180 would still prevent the breaker from operating.

Under another embodiment, FIG. 9 illustrates a block diagram of breaker attachment 218 illustrating the control of hammer movement in a closed loop sensor system that communicates with a controller 280 supplying current to first and second magnetic coils 242 and 244. The closed loop sensor system includes two sensors. A first sensor is a hammer position sensor 282 that is located axially in-line with hammer 208 and interfaces with accumulator or chamber 207 through a threaded hole and seals with accumulator or chamber 207 with a plurality O-rings as illustrated in FIG. 6. A second sensor is one or a series of more than one dead blow sensors 284 placed along a length of tool 202 as illustrated in FIG. 6. In one embodiment, each of first and second sensors 282 and 284 are light-based sensors, such as laser-optical sensors. However, other sensors are possible including Hall Effect sensors, pressure sensors, ultrasonic sensors and the like. Regardless, first and second sensors 282 and 284 include pressure and vibration ratings that can withstand expected operation pressures and vibrations.

First sensor or hammer position sensor 282, when light-based sensor, uses reflected laser light to accurately measure the linear position of hammer 208 and optimize the timing of providing current to coil 242 for activating the compression stroke and to coil 244 for activating the fire stroke. As illustrated in FIG. 6 and under one embodiment, the signal from hammer position sensor 282 is provided to controller 280 and in turn controller 280 electrically activates or provides electrical current to one of first coil 242 or second coil 244 from the power machine via power machine interface 224 based on the signal of hammer position sensor 282 to activate the compression stroke or the firing stroke. Second sensor or dead blow sensor 284, when light-based, operates via line-of-sight to ensure presence of hammer 208 and or tool 202 at the location of dead blow sensor 284 to initiate hammer movement. Dead blow sensor 284 provides a signal if a laser light is blocked by either hammer 208 or tool 202.

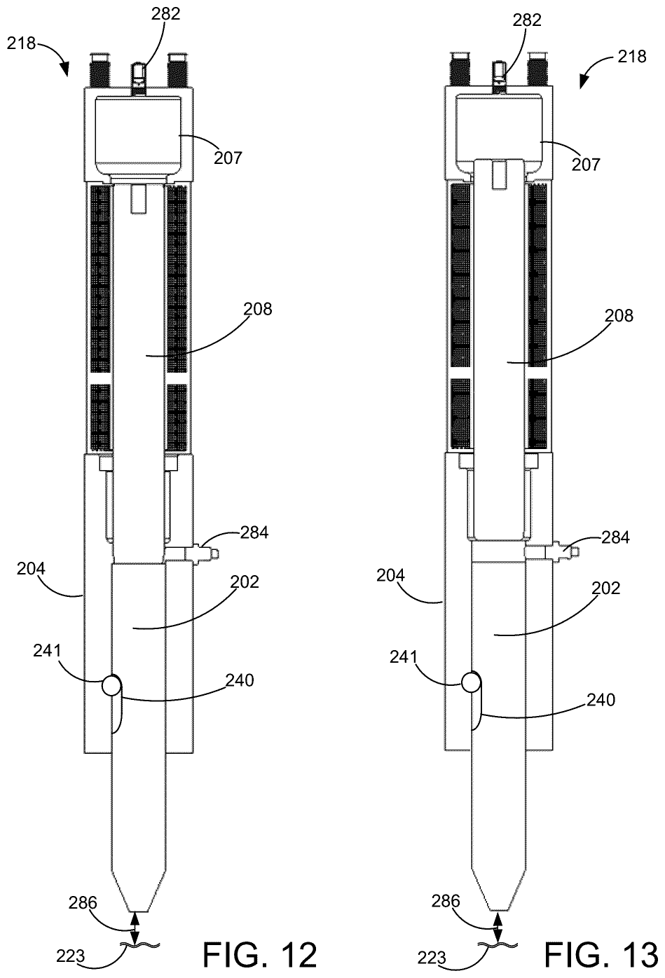

Under one embodiment, controller 280 is configured to combine signals from hammer position sensor 282 and dead blow sensor 284 to ensure both hammer 208 and tool 202 are in the correct positions to operate. If hammer 208 or tool 202 is not in the path of dead blow sensor 284, and/or the position of hammer 208 is measured outside of a predetermined operation range, controller 280 determines that breaker 218 cannot be operated. This prevents firing of hammer 208 into empty space, otherwise known as a “dead-blow,” which is an unhealthy condition for breaker 218. Two such “dead-blow” positions are shown in FIGS. 12 and 13 and caused by the operator not having tool 202 loaded up against structure 223 that the operator is trying to break. If firing of hammer 208 is not prevented in a “dead-blow” position, damage to internal components in breaker 218 may occur because all of the energy of the firing stroke is acted against the breaker itself instead on structure 223.

In first exemplary “dead-blow” position in FIG. 12, there is a gap 286 between tool 202 and structure 223. Gravity causes tool 202 to slide in lower body housing 204 to its lowest position as allowed by pin 241. As illustrated in FIG. 13, dead blow sensor 284 would sense the absence of tool 202 and therefore tool 202 being in the incorrect position. This signal is fed to controller 280 and controller 280 prevents the breaker from operating. In second exemplary “dead-blow” position in FIG. 13, there is also gap 286 between tool 202 and structure 223 and gravity has caused tool 202 to slide in lower body housing 204 to its lowest position as allowed by pin 241. However, as illustrated in FIG. 13, dead blow sensor 284 would sense the presence of hammer 208, which is jammed up or stuck in the cavity and therefore mistakenly inform controller 280 that tool 202 is in the correct position. In this situation, hammer position sensor 282 would sense that hammer 208 is out of position and controller 280 would still prevent the breaker from operating.

Although the present invention has been described with reference to preferred embodiments, workers skilled in the art will recognize that changes may be made in form and detail without departing from the spirit and scope of the invention.

What is claimed is:

1. An attachment on a power machine comprising:
an elongated hammer including an upper end in sealed communication with a gas accumulator and an opposing lower end;
an elongated tool including an upper end having an impact surface and an opposing lower end having a work surface, wherein the tool is configured to be actuated when the lower end of the hammer collides with the impact surface of the tool; and
at least one electromagnetic coil that surrounds a portion of the hammer and being configured to actuate the hammer into a compression stroke that moves the hammer in a first direction and a firing stroke that is further aided by compressed gas in the gas accumulator to move the hammer in a second opposing direction and cause the lower end of the hammer to collide with the impact surface of the tool to actuate the tool.

2. The attachment of claim 1, wherein the at least one electromagnetic coil comprises a single electromagnetic coil.

3. The attachment of claim 2, wherein during the compression stroke the single electromagnetic coil is provided with a first pulse of electrical current to create a first temporary magnetic field that induces a center of the hammer located between the upper end and the opposing lower end to move in the first direction to align with a center of the single electromagnetic coil.

4. The attachment of claim 3, wherein during the firing stroke the single electromagnetic coil is provided with a second pulse of electrical current to create a second temporary magnetic field that induces the center of the hammer to move in the second opposing direction to align with the center of the single electromagnetic coil.

5. The attachment of claim 1, wherein the at least one electromagnetic coil comprises a first electromagnetic coil surrounding a first portion of the hammer and a second electromagnetic coil spaced apart from the first electromagnetic coil and surrounding a second portion of the hammer, wherein a height of the first electromagnetic coil is greater than a height of the second electromagnetic coil.

6. The attachment of claim 5, wherein during the compression stroke the first electromagnetic coil is provided with a first pulse of electrical current to create a first temporary magnetic field that induces a center of the hammer to move in the first direction to align with a center of the first electromagnetic coil.

7. The attachment of claim 6, wherein during the firing stroke the second electromagnetic coil is provided with a second pulse of electrical current to create a second temporary magnetic field that induces the center of the hammer to move in the second opposing direction to align with a center of the second electromagnetic coil.

8. The attachment of claim 1, further comprising a hammer position sensor spaced apart from and located above the upper end of the hammer and configured to measure a location of the upper end of the hammer relative to the hammer position sensor, wherein the hammer position sensor is located through a wall in the gas accumulator.

9. The attachment of claim 8, further comprising a controller configured to activate the at least one electromagnetic coil with first and second pulses of electrical current based on measurements gathered from the hammer position sensor.

10. The attachment of claim 1, further comprising a dead blow sensor located along a length of the hammer or the tool and configured to sense presence of the hammer or tool at the location of the dead blow sensor.

11. The attachment of claim 10, further comprising a controller configured to prevent operation of the hammer based on the dead blow sensor not sensing the presence of the hammer or tool at the location of the dead blow sensor.

12. An attachment on a power machine comprising:
an elongated hammer including an upper end in sealed communication with a gas accumulator and an opposing lower end;
an elongated tool including an upper end having an impact surface and an opposing lower end having a work surface, wherein the tool is configured to be actuated when the lower end of the hammer collides with the impact surface of the tool;
a hammer position sensor spaced apart from and located above the upper end of the hammer and configured to measure a location of the upper end of the hammer relative to the hammer position sensor, wherein the hammer position sensor is located through a wall in the gas accumulator; and
a controller configured to electrically activate the hammer into a compression stroke and a firing stroke based on measurements gathered from the hammer position sensor.

13. The attachment of claim 12, further comprising a single electromagnetic coil surrounding a portion of the elongated hammer, wherein during a compression stroke the controller provides the single electromagnetic coil with a first pulse of electrical current to create a first temporary magnetic field that induces the hammer to move in a first direction and wherein during a firing stroke and aided by compressed gas in the gas accumulator the controller provides the single electromagnetic coil with a second pulse of electrical current to create a second temporary magnetic field that induces the hammer to move in an opposing second direction from the first direction to cause the lower end of the hammer to collide with the impact surface of the tool to actuate the tool.

14. The attachment of claim 12, further comprising a first electromagnetic coil surrounding a first portion of the hammer and a second electromagnetic coil spaced apart from the first electromagnetic coil and surrounding a second portion of the hammer, wherein a height of the first electromagnetic coil is greater than a height of the second electromagnetic coil.

15. The attachment of claim 14, wherein during the compression stroke the first electromagnetic coil is provided with a first pulse of electrical current to create a first temporary magnetic field that induces a center of the hammer to move in the first direction to align with a center of the first electromagnetic coil and wherein during the firing stroke the second electromagnetic coil is provided with a second pulse of electrical current to create a second temporary magnetic field that induces the center of the hammer to move in the second opposing direction to align with a center of the second electromagnetic coil.

16. The attachment of claim 12, further comprising a dead blow sensor located along a length of the hammer or the tool and configured to sense presence of the hammer or tool at the location of the dead blow sensor, wherein the controller is configured to prevent operation of the hammer based on the dead blow sensor not sensing the presence of the hammer or tool at the location of the dead blow sensor.

17. An attachment on a power machine comprising:
an elongated hammer including an upper end in sealed communication with a gas accumulator and an opposing lower end;
an elongated tool including an upper end having an impact surface and an opposing lower end having a work surface, wherein the tool is configured to be actuated when the lower end of the hammer collides with the impact surface of the tool; and
at least one electromagnetic coil that surrounds a portion of the elongated hammer; and
a controller configured to electrically activate the at least one electromagnetic coil to actuate the elongated hammer into a compression stroke that moves the hammer in a first direction and a firing stroke that is further aided by compressed gas in the gas accumulator to move the hammer in a second opposing direction and cause the lower end of the hammer to collide with the impact surface of the tool to actuate the tool.

18. The attachment of claim 17, wherein the at least one electromagnetic coil comprises a single electromagnetic coil, wherein during the compression stroke the single electromagnetic coil is provided with a first pulse of electrical current to create a first temporary magnetic field that induces a center of the elongated hammer to move in the first direction to align with a center of the single electromagnetic coil and wherein during the firing stroke the single electromagnetic coil is provided with a second pulse of electrical current to create a second temporary magnetic field that induces the center of the elongated hammer to move in the second opposing direction to align with the center of the single electromagnetic coil.

19. The attachment of claim 17, wherein the at least one electromagnetic coil comprises a first electromagnetic coil surrounding a first portion of the hammer and a second electromagnetic coil spaced apart from the first electromagnetic coil and surrounding a second portion of the hammer, wherein during the compression stroke the first electromagnetic coil is provided with a first pulse of electrical current to create a first temporary magnetic field that induces a center of the elongated hammer to move in the first direction to align with a center of the first electromagnetic coil and wherein during the firing stroke the second electromagnetic coil is provided with a second pulse of electrical current to create a second temporary magnetic field that induces the center of the elongated hammer to move in the second opposing direction to align with a center of the second electromagnetic coil.

20. The attachment of claim 17, further comprising a hammer position sensor spaced apart from and located above the upper end of the hammer and through a wall in the gas accumulator, wherein the hammer position sensor is configured to measure a location of the upper end of the hammer relative to the hammer position sensor and wherein the controller is configured to actuate the hammer into the compression stroke and the firing stroke based on measurements gathered from the hammer position sensor.
